(19) United States
(12) Patent Application Publication
(10) Pub. No.: US 2014/0095386 A1
(43) Pub. Date: Apr. 3, 2014

(54) Universal Substantiation System

(71) Applicant: WAL-MART STORES, INC., Bentonville, AR (US)

(72) Inventors: Jason Marshall, Fayetteville, AR (US); Kara Kazazean, Rogers, AR (US)

(73) Assignee: Wal-Mart Stores, Inc., Bentonville, AR (US)

(21) Appl. No.: 13/632,491

(22) Filed: Oct. 1, 2012

(51) Int. Cl. G06Q 20/40

(52) U.S. Cl. 705/44

(57) ABSTRACT

A universal substantiation system and method that can be used to allow or prevent a consumer to purchase products or services using a payment or identification device having one or more rules or conditions.

### FIELD OF THE DISCLOSURE

Some embodiments of the present disclosure relate generally to the field of a substantiation system that may enable or prevent the purchase of products or services using a payment or identification device having rules or conditions. More particularly, some embodiments of the present disclosure relate to the field of a universal substantiation system for a merchant that may enable or prevent the consumers to purchase products or services using a payment or identification device having predetermined rules or conditions.

### BACKGROUND OF THE DISCLOSURE

Payment for products and services with payment devices, such as, a gift card, or a stored-value card, has become increasingly popular in recent years due, in part, to the ease and speed of performing purchase transactions. For example, a consumer may visit a location (e.g., retail store or website) associated with a merchant to purchase products or services. The consumer may use the payment devices to purchase the products or services from the merchant. Generally, a gift card is a type of stored-value card that includes pre-loaded or selectively loaded monetary value. In one example, a consumer may purchase a gift card having a specified value for presentation as a gift to another person. The person may use the gift card to purchase the desired products or services.

With an increase in the popularity of the gift card, the number of entities issuing and accepting the gift card has also increased. For example, banks, credit card companies, various types of merchants have all started to issue and accept gift cards. Also, the types of gift cards issued by various entities have increased. For example, gift cards may be a physical card that contains bar codes or magnetic strips, the gift cards may be re-loadable or rechargeable, delivered to mobile phones or electronic mail accounts. Some merchants may have difficult time monitoring and tracking the gift cards as the number of entities issuing the gift cards and the types of gift cards increase.

In view of the foregoing, there is a need for increase of efficiency in monitoring and tracking the usage of gift cards. There is also a need for a universal system for issuing various types of gift cards by various entities. There is further a need for a universal system for substantiate the various gift cards issued by the various entities.

### SUMMARY OF THE DISCLOSURE

Some embodiments of the present disclosure address at least the issues discussed above.

In accordance with one embodiment of the present disclosure a substantiation system for substantiating a payment device may include a payer/partner module including at least one computer processor configured to receive payer/partner identification information from a payer/partner. The substantiation system may also include a payer/partner account module configured to create a payer/partner substantiation account based at least in part on the payer/partner identification information. The substantiation system may further include a programming module configured to receive programming information to create one or more program profiles for the payer/partner substantiation account. Furthermore, the substantiation system may include a rules/conditions module configured to receive one or more rules or conditions for the payment device associated with the one or more program profiles of the payer/partner substantiation account, wherein the one or more rules or conditions control products or services that can be purchased using the payment device.

In accordance with another embodiment of the present disclosure a method for substantiating a payment device may be provided. The method may include receiving, via a payer/partner module comprising at least one computer processor, payer/partner identification information from a payer/partner to create a payer/partner substantiation account. The method may also include the step of receiving programming information to create one or more program profiles for the payer/partner substantiation account. The method may further include the step of receiving one or more rules or conditions for the payment device associated with the one or more program profiles of the payer/partner substantiation account, wherein the one or more rules or conditions control products or services that can be purchased using the payment device.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 shows an exemplary universal substantiation system in accordance with the present disclosure.

FIG. 2 shows an exemplary substantiation system of the universal substantiation system in accordance with the present disclosure.

FIG. 3 shows an exemplary flow diagram for substantiate a payment or identification device using the substantiation system of the universal substantiation system in accordance with the present disclosure.

FIG. 4 shows an exemplary flow diagram of a consumer using the substantiation system of the universal substantiation system in accordance with the present disclosure.

FIG. 5 shows an exemplary flow diagram of a payer/partner using the substantiation system of the universal substantiation system in accordance with the present disclosure.

### DETAILED DESCRIPTION OF THE EMBODIMENTS

An embodiment of the present disclosure is directed to a universal substantiation system that may allow or prevent consumers to purchase products or services via a payment or identification device having rules or conditions. For example, various payers/partners may access a substantiation system of a merchant to create payment or identification devices having rules or conditions. The various payers/partners or the merchant may distribute the payment or identification devices to the consumers. The merchant may substantiate the payment or identification devices when the payment or identification devices are used to purchase products or services. For example, the merchant may validate whether the purchased products or services violates the rule or conditions of the payment or identification device. The payment or identification devices may be used to purchase a product or service controlled by the rules and conditions. In another example, the payment or identification devices may be used at a merchant to purchase products or services subject to the rules and conditions.

As used herein, the term “consumer” is interpreted broadly to include any individual or collection of individuals that may use payment or identification devices having rules or conditions to purchase products or services. A consumer includes, but is not limited to, an individual, a household, a corporate entity or any other member that interacts with the payer/partner or the merchant, etc.

As used herein, the term “payer/partner” in interpreted broadly to include any individual, company, corporation, partnership, association, club, foundation, agencies, organization, federal government, state or local governments, charities that may obtain the payment or identification devices having rules or conditions for the consumers. Also, the payer/partner includes, but is not limited to, an entity or any other organizations that may access the universal substantiation system to obtain payment or identification devices for the consumers.

As used herein, the term “merchant” is interpreted broadly to include any individual, retail stores, retail chains, websites, service providers, and/or other organization that may sell products or services to consumers. Also, the merchant includes, but is not limited to, any entity that may sell products or services to consumers.

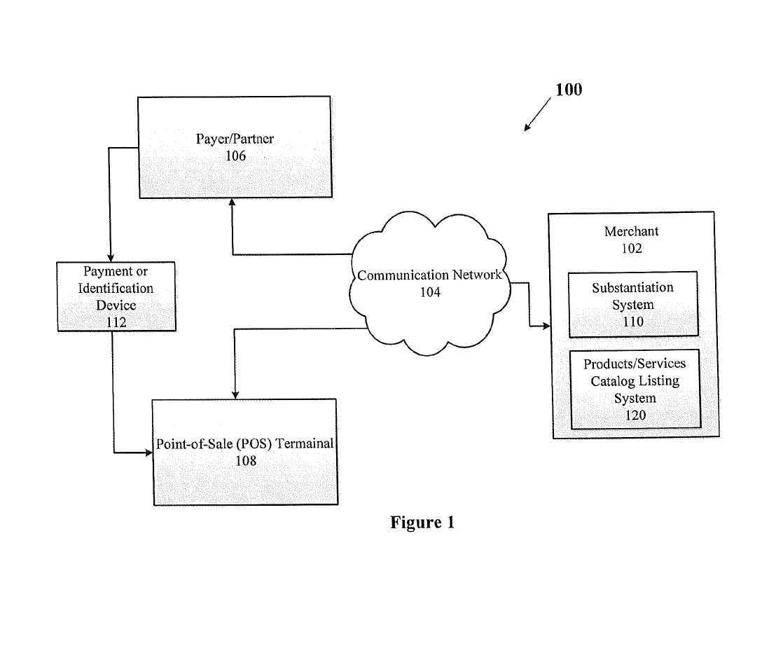

Referring now to the figures wherein like reference numbers refer to like elements, FIG. 1 shows an exemplary embodiment of the universal substantiation system 100 that may allow or prevent consumers to purchase products or services using payment or identification devices having rules or conditions. As depicted in FIG. 1, a payer/partner 106 may access a substantiation system 110 hosted by a merchant 102 via a communication network 104 to obtain a payment or identification device 112 having rules or conditions. Also, the substantiation system 100 may allow payers/partners 106 to access a products/services catalog listing system 120 associated with the merchant to offer products or services for purchase by consumers. The payers/partners 106 may subject all or some of the products or services in the products/services catalog listing system 120 to the rules or conditions. The substantiation system 110 may allow various payers/partners 106 to obtain a plurality of different types of payment or identification device 112 having different rules or conditions. The payment or identification device 112 may be distributed to the consumers by the payer/partner 106 or the merchant 102. For example, the payment or identification device 112 may be distributed to consumers via the products/services catalog listing system 120 of the merchant 102. The payment or identification device 112 may be listed on the products/services catalog listing system 120 of the merchant 102 by the payer/partner 106 and offered for purchase by the consumers. The consumer may use the payment or identification device 112 to purchase products or services at a point-of-sale (POS) terminal 108. The substantiation system 110 may substantiate the payment or identification device 112 when used to purchase products or services. The substantiation system 110 may determine whether the purchased products or services are subject to the rules or conditions. If so, the substantiation system 110 may determine whether the purchased products or services violate or in accordance with rules or conditions of the payment or identification device 112. The substantiation system 110 may authorize the purchase of products or services or provide a benefit when the purchased products or services do not violate rules or conditions of the payment or identification device 112. The substantiation system 110 may deny the purchase of products or services or provide a benefit when the purchased products or services violate rules or conditions of the payment or identification device 112.

In an example, the payer/partner 106 may be an insurance company or a health care provider organization that may access the substantiation system 110 to create a wellness program. The wellness program may be associated with preventive dental care for members of the insurance company or the health care provider organization. The wellness program may be implemented by the payer/partner 106 in order to promote increase the awareness of the dental hygiene among the members of the payer/partner 106. The payer/partner 106 may assign rules or conditions to the wellness program. For example, the payer/partner 106 may assign rules or conditions to the wellness program by accessing the products/services catalog listing system 120 to select products or services for the wellness program. The payer/partner 106 may select tooth brush, tooth paste, mouth wash and floss from the products/services catalog listing system 120 to the wellness program. The payment or identification device 112 may be distributed to the member of the payer/partner 106. The payment or identification device 112 may be associated with an account created by the substantiation system 110. The payment or identification device 112 may access the account created by the substantiation system 110 to purchase the products or services offered by the wellness program from the merchant 102.

The payer/partner 106 may assign rules or conditions to the payment or identification device 112. The payer/partner 106 may assign the payment or identification device 112 to purchase a category (e.g., medical) of products or services. The payer/partner 106 may assign the payment or identification device 112 to purchase a specific product (e.g., organic eggs) or service (e.g., tire installation). The payer/partner 106 may assign a specific time period to use the payment or identification device 112. The payer/partner 106 may further assign the payment or identification device 112 to be substantiated at a particular merchant (e.g., Wal-Mart®). Moreover, payer/partner 106 may distribute the payment or identification device 112 to a group of consumers (e.g., member of a group).

Also, the payer/partner 106 may distribute the payment or identification device 112 to the consumer. For example, the payer/partner 106 may access the products/services catalog listing system 120 and provide the payment or identification device 112 to the consumer. The payer/partner 106 may create an account with the products/service catalog listing system 120 approved by the merchant 102. The payer/partner 106 may access the account and offer the payment or identification device 112 to the consumers. For example, the payment or identification device 112 may be listed in the products/services catalog listing system 120 of the merchant and offered to the consumers. The consumer may browse the products/service catalog listing system 120 (e.g., via the web or retail store) and purchase or obtain the payment or identification device 112.

The merchant 102 may include one or more servers to provide the substantiation system 110 and the products/services catalog listing system 120 to the payer/partner 106 and the point-of-sale (POS) terminal 108 via the communication network 104. For example, the merchant 102 may include Apache HTTP server, API server, ASP server, PHP server, HTTP server, IP server, or other independent server to host the substantiation system 110 and the products/services catalog listing system 120 and provide access to the payer/partner 106 and/or the point-of-sale (POS) terminal 108. Also, the merchant 102 may include one or more Internet Protocol (IP) network server or public switch telephone network (PSTN) server. The merchant 102 may also include one or more databases for storing the substantiation system 110 and the products/services catalog listing system 120.

The communication network 104 may couple the payer/partner 106 and the point-of-sale (POS) terminal 108 to the merchant 102, the substantiation system 110 and the products/services catalog listing system 120. The communication network 104 may be a wireless network, a wired network or any combination of wireless network and wired network. For example, the communication network 104 may include one or more of a fiber optics network, a passive optical network, a cable network, an Internet network, a satellite network (e.g., operating in Band C, Band Ku or Band Ka), a wireless LAN, a Global System for Mobile Communication (GSM), a Personal Communication Service (PCS), a long term evolution (LTE), a Personal Area Network (PAN), D-AMPS, Wi-Fi, Fixed Wireless Data, IEEE 802.11a, 802.11b, 802.15.1, 802.11n and 802.11g or any other wired or wireless network for transmitting and receiving a data signal. In addition, the communication network 104 may include, without limitation, telephone line, fiber optics, IEEE Ethernet 802.3, wide area network (WAN), local area network (LAN), or global network such as the Internet. The communication network 104 may support an Internet network, a wireless communication network, a cellular network, or the like, or any combination thereof.

The communication network 104 may further include one, or any number of the exemplary types of networks mentioned above operating as a stand-alone network or in cooperation with each other. Although the communication network 104 is depicted as one network, it should be appreciated that according to one or more embodiments, the communication network 104 may include a plurality of interconnected networks, such as, for example, a service provider network, the Internet, a broadcaster's network, a cable television network, corporate networks, and home networks.

The payer/partner 106 may include one or more user devices to access the substantiation system 110 and the products/services catalog listing system 120. The user devices may include mobile user device, a computer, a personal computer, a laptop, a cellular communication device, a workstation, a mobile device, a phone, a television, a handheld PC, a personal digital assistant (PDA), a thin system, a fat system, a network appliance, an Internet browser, or other any other device that may be in communication with the substantiation system 110 and the products/service catalog listing system 120 via the communication network 104. Other user devices of the payer/partner 106 may be one or more intermediary devices that may communicate with the communication network 104, such as a transmitter/receiver, router, modem, or a set-top box. The plurality of user devices of the payer/partner 106 may be coupled to the substantiation system 110 and the products/services catalog listing system 120 via a wired link. In another example, the plurality of user devices of the payer/partner 106 may be coupled to the substantiation system 110 via a wireless link.

The point-of-sale (POS) terminal 108 may include a scanner, a reader, and/or other detection devices that may identify products or services. For example, the scanners or the readers at the point-of-sale (POS) terminal 108 may include barcode reader, radio-frequency identification (RFID) detector, infrared detector, bluetooth detector, laser scanner, cameras, near-field communication devices, image scanner, and/or other detection devices that may identify products or services. The point-of-sale (POS) terminal 108 may also include a mobile user device, a computer, a personal computer, a laptop, a cellular communication device, a workstation, a mobile device, a personal digital assistant (PDA), a thin system, a fat system, a network appliance, an Internet browser, or other any other device that may be in communication with the substantiation system 110 and the products/service catalog listing system 120. The point-of-sale (POS) terminal 108 may further include one or more intermediary devices that may communicate with the communication network 104, such as a transmitter/receiver, router, modem, or a set-top box. The point-of-sale (POS) terminal 108 may be coupled to the substantiation system 110 of the merchant 102 via a wired link. In another example, the point-of-sale (POS) terminal 108 may be coupled to the substantiation system 110 via a wireless link.

The payment or identification device 112 may be associated with an account created by the substantiation system 110. The payment or identification 112 may enable consumer to access the account created by the substantiation system 110 in order to purchase products or services from the merchant 102. The payment or identification device 112 may include any credit card, debit card, stored-value card, gift card, voucher card, wage card, virtual card, electronic-email card, membership card, identification card, and/or other cards that may be used to purchase products or services from the merchant 102 or the point-of-sale (POS) terminal 108. Also, the payment or identification device 112 includes, but is not limited to, a card that may be substantiated by the merchant 102. In other embodiments, the payment or identification device 112 may include virtual or digital card, for example, but not limited to, an email, a code, a pattern, a certificate and/or other identification that may provide access to the account created by the substantiation system 110.

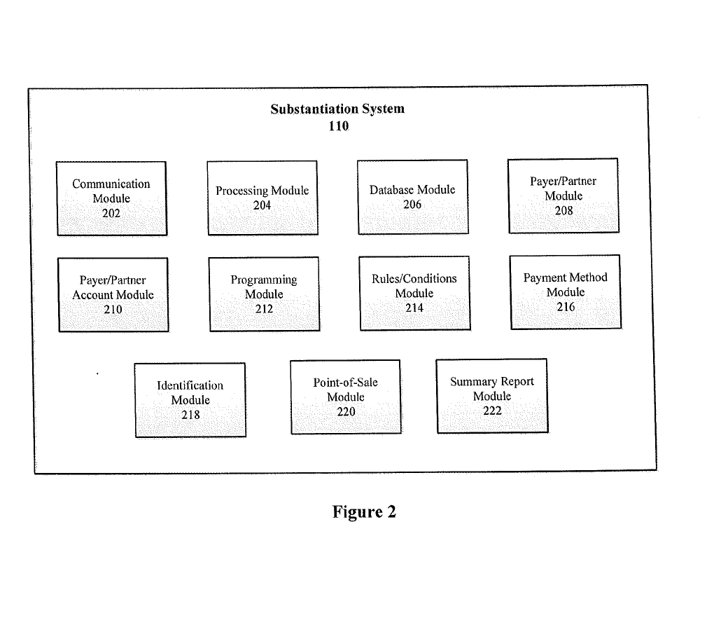

FIG. 2 is a block diagram of hardware components of the substantiation system 110 of the universal substantiation system 100 in accordance with an embodiment of the present disclosure. The substantiation system 110 may include a communication module 202, a processing module 204, a database module 206, a payer/partner module 208, a payer/partner account module 210, a programming module 212, a rules/conditions module 214, a payment method module 216, an identification module 218, a point-of-sale (POS) module 220 and a summary report module 222. It is noted that modules 202-222 are exemplary and the functions performed by one or more of the modules may be combined with that performed by other modules. The functions described herein as being performed by modules 202-222 also may be separated and may be located or performed by other modules.

The communication module 202 may include transceivers and a computer processor to establish a communication with the products/services catalog listing system 120, the payer/partner 106 and the point-of-sale (POS) terminal 108 via the communication network 104. The communication module 202 may provide an interface to enable the products/services catalog listing system 120 with the substantiation system 110. The communication module 202 may provide an interface to enable the payer/partner 106 to communicate with the substantiation system 110. The communication module 202 may also provide an interface to enable the point-of-sale (POS) terminal 108 to communicate with the substantiation system 110. The communication module 202 may include a user interface (e.g., a graphical user interface (GUI) or an application programming interface (API)) to transmit information between the substantiation system 110 and the payer/partner 106 or the point-of-sale (POS) terminal 108. For example, the communication module 202 may include a separate or unified graphical user interface to communicate with the payer/partner 106. In another example, the communication module 202 may include an application programming interface (API) to communicate with the products/services catalog listing system 120 and the point-of-sale (POS) terminal 108. The communication module 202 may be communicatively coupled to other modules of the substantiation system 110. For example, the communication module 202 may receive information from the products/services catalog listing system 120, the payer/partner 106 and the point-of-sale (POS) terminal 108 and provide the information to other modules of the substantiation system 110. The communication module 202 may provide the received information to the processing module 204 for processing or the database module 206 for storing.

The payer/partner module 208 may include at least one computer processor and a user interface to prompt the payer/partner 106 for payer/partner identification information. The payer/partner identification information may include name, address, phone number, electronic mail address, website address, revenue, profit, number of employees, types of payer/partner, contact person of the payer/partner and/or other information that may identify the payer/partner 106. The payer/partner module 208 may receive and store the payer/partner identification information from the payer/partner 106 and provide the payer/partner identification information to other modules of the substantiation system 110. The payer/partner module 208 may also include a database to store the payer/partner identification information or provide the payer/partner identification information to the database module 206 and stored. Also, the payer/partner module 208 may enable the payer/partner 106 access to the products/services catalog listing system 210. For example, the payer/partner module 208 may enable the payer/partner 106 to offer payment or identification device 116 to the consumer via the products/services catalog listing system 210.

The payer/partner module 208 may provide the payer/partner identification information to the processing module 208 and the payer/partner account module 210 to create a substantiation account for the payer/partner 106. The payer/partner account module 210 may include a computer processor and a database to assign one of a plurality levels to the payer/partner substantiation account based at least in part on the payer/partner identification information. Each of the plurality of levels of the payer/partner substantiation account may offer different incentive or rewards to the payer/partner 106 for using the substantiation system 110. For example, the payer/partner account module 210 may assign a standard level, a silver level, a gold level, a platinum level or any other levels to a payer/partner substantiation account. For example, the payer/partner account module 210 may assign a standard level to a payer/partner substantiation account when the payer/partner 106 conducts less than one million dollars' worth of transactions using the substantiation system 110. In another example, the payer/partner account module 210 may assign a silver level to a payer/partner substantiation account when the payer/partner 106 conducts over one million dollars' worth of transactions using the substantiation system 110. In another example, the payer/partner account module 204 may assign a gold level to a payer/partner substantiation account when the payer/partner 106 conducts over ten million dollars' worth of transactions using the substantiation system 110. In other examples, the processing module 204 may assign a platinum level payer/partner substantiation account when the payer/partner 106 conducts over twenty million dollars' worth of transactions using the substantiation system 110.

The payer/partner account module 210 may create a plurality of accounts for a program created by the payer/partner 106. For example, the payer/partner account module 210 may create a plurality of accounts for a wellness program created by the payer/partner 106. Each of the plurality of accounts created by the payer/partner account module 210 may be associated with a unique payment or identification device 112. For example, the payment or identification device 112 may be used at the point-of-sale module 220 to access accounts created by the payer/partner account module 210 in order to purchase products or services subject to the rules and conditions of the rules/conditions module 214.

The payer/partner account module 210 may assign an incentive or reward to the payer/partner account. For example, the payer/partner account module 210 may assign different incentives or rewards to different levels of the payer/partner substantiation account. The payer/partner account module 210 may assign no reward for the standard level payer/partner substantiation account. The payer/partner account module 210 may assign a one percent reward (e.g., one percent of transactions conducted using the substantiation system 110) to the silver level payer/partner substantiation account. The payer/partner account module 210 may assign two percent reward (e.g., two percent of transactions conducted using the substantiation system 110) for gold level payer/partner account. The payer/partner account module 210 may assign four percent reward (e.g., four percent of transactions conducted using the substantiation system 110) to platinum level payer/partner substantiation account. The processing module 204 may determine an amount of reward assigned to the payer/partner 106 based at least in part on a level assigned to the payer/partner substantiation account. The payer/partner account module 210 may assign other levels of rewards to other payer/partner substantiation account.

The programming module 212 may include a computer processor and a database to prompt the payer/partner 106 for programming information to create program profiles associated with a payment or identification device 112. The programming module 212 may create a program profile based at least in part on the programming information provided by the payer/partner 106. The programming module 212 may create a plurality of program profiles for each of the payer/partner substantiation account. The programming module 212 may associate the program profile with the payer/partner substantiation account of the payer/partner 106. For example, the programming module 212 may create a health and wellness program profile categorized under a payer/partner substantiation account. In another example, the programming module 212 may create a meal card program profile categorized under a payer/partner substantiation account. In other examples, the programming module 212 may create a membership program profile categorized under the payer/partner substantiation account.

The payer/partner 106 may provide rules or conditions of the payment or identification devices 112 associated with a program profile of a payer/partner substantiation account. The payer/partner 106 may provide the rules or conditions of the payment or identification devices 112 to the rules/conditions module 214. The rules/conditions module 214 may create different rules or conditions for different program files of the payer/partner substantiation account. For example, the rules/conditions module 214 may create an inclusion/exclusion list of products or services for a program profile of a payer/partner substantiation account. The rules/conditions module 214 may create an inclusion/exclusion list that includes a generic brand of aspirin and excludes a name brand of aspirin. In another examples, the rules/conditions module 214 may create an inclusion/exclusion list that includes members of the payer/partner 106 and excludes non-members of the payer/partner 106. The rules/conditions module 214 may create categories of products and services for a program profile of a payer/partner substantiation account associated with a payment or identification device 112. For example, the rules/conditions module 214 may create an organic food category for a program profile associated with the payment or identification device 112, wherein the payment or identification device 112 may be used to purchase organic food. In another example, the rules/conditions module 214 may create an electronic products or services category for a program profile associated with the payment or identification device 112, wherein the payment or identification device 112 may be used to purchase electronic equipment.

The rules/conditions module 214 may create a valid duration associated with the payment or identification device 112. For example, the rules/conditions module 214 may assign the payment or identification device 112 a validation period of one year from the date of issuance. The consumer may have a year to use the payment or identification device 112 having rules or conditions to purchase products or services. The rules/conditions module 214 may create a dollar amount for the payment or identification device 112. For example, the rules/conditions module 214 may create a one hundred dollar limit for the payment or identification device 112 towards the purchase of products or services. The rules/conditions module 214 may create a membership condition to utilize the payment or identification device 112. For example, the rules/conditions module 214 may require that the consumer is a member of the payer/partner 106 in order to utilize the payment or identification device 112. The rules/conditions module 214 may create a merchant condition for the payment or identification device 112. For example, the rules/conditions module 214 may require the consumer to use the payment or identification device 112 at a particular merchant (e.g., Wal-Mart®). The rules/conditions module 214 may create other rules or conditions provided by the payer/partner 106 to utilize the payment or identification device 112.

The rules/conditions module 214 may create discounts, rebates or rewards associated with the payment or identification device 112. For example, the rules/conditions module 214 may assign a ten percent discount for using the payment or identification device 112 to purchase products or services from the merchant 102. In another example, the rules/conditions module 214 may provide a five dollar rebate (e.g., gift card) for using the payment or identification device 112. In other embodiments, the rules/conditions module 214 may provide a reward for using the payment or identification device 112. The rewards may include, but not limited to, a product or service offered by the merchant 102 or rewards points that may be used to purchase products or services. The rules/conditions module 214 may create discounts, rebates or rewards for the usage of the payment or identification device 112. For example, the rules/conditions module 214 may assign discount, rebates or rewards for a predetermine amount of usage of the payment or identification device 112. The predetermine amount of usage may include a frequency of usage (e.g., once a week) of the payment or identification device 112 or a monetary amount of usage (e.g., $100) of the payment or identification device 112.

The payment method module 216 may include a computer processor and a database to create various kinds of payment or identification device 112 determined by the payer/partner 106. The payment method module 216 may provide a graphical user interface (GUI) to prompt the payer/partner 106 for a selection of a type of payment method. For example, the payment method module 216 may create a credit card, a debit card, a gift card, a stored-value card, a smart card, a voucher, an electronic mail, a scan code, and/or other devices that may facilitate the purchase of products or services. The payment method module 216 may create a gift card that may be distributed to the consumer via mail or retail store. In another example, the payment method module 216 may create a virtual card that may be distributed to the consumer via electronic-mail or a smart phone of the consumer. In other examples, the payment method module 216 may create a membership card that may entitle a member to purchase products or services.

The identification module 218 may include a computer processor and a database for creating and storing identification information associated with the payment or identification device 112. For example, the identification module 218 may assign a unique identification number to each of the payment or identification device 112. The identification module 218 may randomly generate a unique identification number to each of the payment or identification device 112. The identification module 218 may store the unique identification number of each of the payment or identification device 112. When the payment or identification device 112 is used to purchase products or services, the identification module 218 may verify whether the payment or identification device 112 used is valid by comparing the unique identification number of the used payment or identification device 112 with the unique identification number stored.

The consumer may utilize the payment or identification device 112 to purchase products or services at the point-of-sale (POS) terminal 108. The point-of-sale (POS) terminal 108 may establish a communication with the communication module 202 of the substantiation system 110 and the products/services catalog listing system 120. The point-of-sale (POS) terminal 108 may access the products/services catalog listing system 120 in order to obtain transaction information and/or products or services information for purchase. The point-of-sale (POS) terminal 108 may provide the transaction information to the communication module 202. The communication module 202 may transfer the transaction information to the point-of-sale (POS) module 220. The point-of-sale (POS) module 220 may include a computer processor or a database to process and store the transaction information. For example, the point-of-sale (POS) module 220 may identify products or services purchased at the point-of-sale (POS) terminal 108. The point-of-sale (POS) module 220 may also identify a time or a date of purchase at the point-of-sale (POS) terminal 108. The point-of-sale (POS) module 220 may further identify an identification information of the payment or identification device 112 used to purchase the products or services. The point-of-sale (POS) module 220 may store the transaction information for a predetermined and/or programmable period of time. For example, the point-of-sale (POS) module 220 may store the transaction information for a duration specified by the payer/partner 106.

The point-of-sale (POS) module 220 may provide the transaction information to the processing module 204 to determine whether the payment or identification device 112 tendered for payment can be used to purchase the products or services. The processing module 204 may include one or more computer processors and databases to access information from various modules of the substantiation system 110. For example, the processing module 204 may access information stored at the payer/partner account module 210, the programming module 212, the rules/conditions module 214, the payment method module 216, the identification module 218 and the point-of-sale (POS) module 220 to determine whether the payment or identification device 112 tendered for payment can be used to purchase the products or services.

For example, the processing module 204 may access payer/partner account module 210 to determine a payer/partner substantiation account associated with the payment or identification device 112 tendered for payment. The processing module 204 may access the programming module 212 to determine a program profile associated with the payment or identification device 112 tendered for payment. The processing module 204 may access the transaction information stored at the point-of-sale (POS) module 220 and identify identification information associated with the payment or identification device 112. The processing module 204 may search the identification module 218 to determine whether identification information stored at the identification module 218 matches the identification information obtained from the transaction information. The processing module 204 may access the programming module 212 to determine whether a program stored at the programming module 212 is associated with the identification information. The processing module 204 may access the rules/conditions module 214 to identify one or more rules or conditions based at least in part on the identification information. For example, the processing module 204 may identify a program profile associated with the identification information and one or more rules or conditions associated with the program profile. The processing module 204 may determine whether the purchased products or services matches a product or service contained in an inclusion/exclusion list stored at the rules/conditions module 214. In another example, the processing module 204 may determine whether the purchased products or services falls under a category of products or services stored at the rules/conditions module 214. The processing module 204 may authorize a transaction when determined that the payment or identification device 112 tendered for payment can be used to purchase the products or services. The communication module 202 may provide an approval message to the point-of-sale (POS) terminal 108 to approve the transaction.

Once the processing module 204 approves a transaction, the processing module 204 may record the transaction information in a summary report module 222. The summary report module 222 may organize the transaction information based at least in part on a program profile or a payer/partner substantiation account for a predetermined and/or programmable period of time. For example, the summary report module 222 may organize the transaction information for a fiscal year, quarter, month, week or any other time period. The summary report module 222 may also organize the transaction information for the duration of the program profile. The summary report module 222 may organize transaction information based at least in part on a program profile. For example, the summary report module 222 may organize transaction information for a child car seat program profile or an organic food program profile. The summary report module 222 may organize transaction information based at least in part on a payer/partner substantiation account. For example, a payer/partner substantiation account may have a plurality of program profiles, the summary report module 222 may organize transaction information for the plurality of program profiles for the payer/partner substantiation account. The summary report module 222 may provide a summary of transaction information of the medication program profile and a health screening program profile for the payer/partner substantiation account of a health care provider.

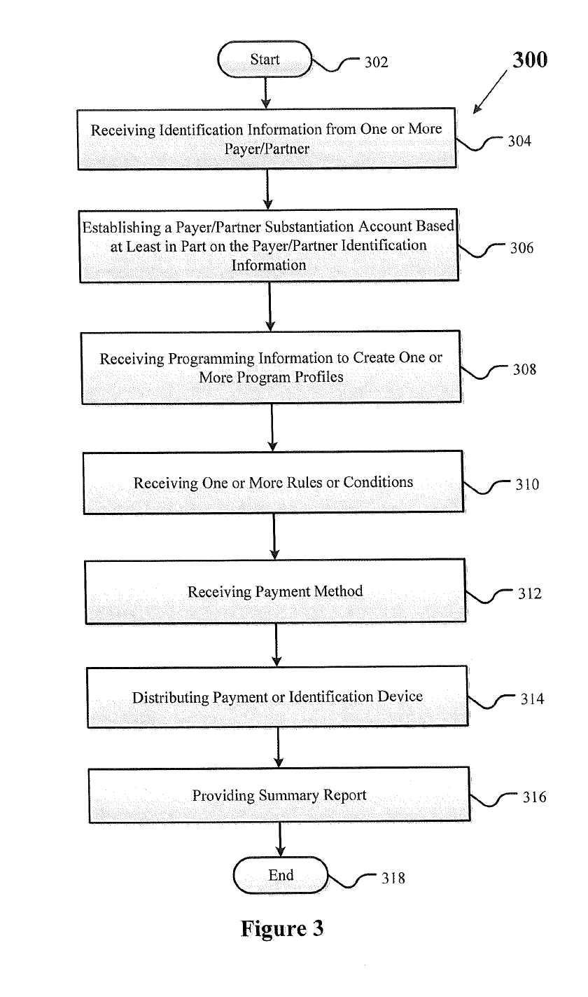

FIG. 3 is a flow chart illustrating the functionality of the substantiation system 110 of the universal substantiation system 100 according to an embodiment of the present disclosure. This exemplary method 300 may be provided by way of example, as there are a variety of ways to carry out the method. The method 300 shown in FIG. 3 can be executed or otherwise performed by one or a combination of various systems. The method 300 is described below may be carried out by the systems and networks shown in FIGS. 1 and 2, by way of example, and various elements of the systems and networks are referenced in explaining the example method of FIG. 3. Each block shown in FIG. 3 represents one or more processes, methods or subroutines carried out in exemplary method 300. Referring to FIG. 3, exemplary method 300 may begin at step 302.

At step 302, the method 300 for substantiate a payment or identification device 112 having rules or conditions using the substantiation system 110 may be started.

At step 304, the substantiation system 110 may receive identification information from one or more payer/partners 106. For example, the payer/partner 106 may establish a communication with the substantiation system 110 via the communication module 202 and the communication network 104. The communication module 202 may enable a communication between the payer/partner 106 and the substantiation system 110. The payer/partner 106 may access the substantiation system 110 to allow or prevent the purchase of products or services using a payment or identification device 112 having rules or conditions. The payer/partner module 208 may prompt the payer/partner 106 to enter and receive payer/partner identification information. The payer/partner identification information may include name, address, phone number, electronic mail address, website address, revenue, profit, number of employees, types of payer/partner, contact person of the payer/partner and/or other information that may identify the payer/partner 106. The payer/partner module 208 may store payer/partner identification information. Also, the payer/partner module 208 may provide the payer/partner identification information to other modules of the substantiation system 110. The payer/partner module 208 may enable the payer/partner 106 access to the products/services catalog listing system 210. For example, the payer/partner module 208 may enable the payer/partner 106 to offer payment or identification device 116 to the consumer via the products/services catalog listing system 210. After receiving identification information from one or more payer/partners, the method 300 may proceed to step 306.

At step 306, the substantiation system 110 may establish a payer/partner substantiation account based at least in part on the payer/partner identification information. For example, the payer/partner account module 210 may obtain payer/partner identification information from the payer/partner module 208. The payer/partner account module 210 may establish a payer/partner substantiation account based at least in part on the payer/partner identification information. The payer/partner account module 210 may assign a reward to the payer/partner substantiation account. For example, the payer/partner account module 210 may assign different rewards to different levels of payer/partner substantiation account. The payer/partner account module 210 may assign no reward for silver level payer/partner account. The payer/partner account module 210 may assign one percent reward for gold level payer/partner substantiation account. The payer/partner account module 210 may also assign two percent reward for platinum level payer/partner substantiation account. For example, the payer/partner account module 210 may assign a level to a payer/partner substantiation account based at least in part on an amount of transaction conducted by the payer/partner 106. After establishing a payer/partner substantiation account based at least in part on the payer/partner identification information, the method 300 may proceed to step 308.

At step 308, the substantiation system 110 may receive programming information to create one or more program profiles. For example, the programming module 212 may prompt the payer/partner 106 to enter programming information to create one or more program profiles associated with the payment or identification device 112. The programming module 212 may provide a graphical user interface (GUI) that may allow the payer/partner 106 to enter programming information. The programming module 212 may establish one or more program profiles for each of the payer/partner substantiation account based at least in part on the received programming information. The payer/partner 106 may choose to have a plurality of programs and the programming module 212 may create a plurality of program profiles for each of the plurality of programs associated with the payer/partner substantiation account. For example, a charity organization may provide programming information to create a natural disaster program such as, but not limited to, an earth quake program, a tsunami program, a famine program, a fire program, a flood program and a tornado program. The programming module 212 may use the programming information provided by the charity organization to create a natural disaster program such as, but not limited to, an earthquake program profile, a tsunami program profile, a famine program profile, a fire program, a flood program profile and a tornado program profile. The programming module 212 may create different program profiles for each of the payer/partner substantiation account. For example, the programming module 212 may create a financial program for a first payer/partner substantiation account. In another example, the programming module 212 may create a disaster relief program for a second payer/partner substantiation account. In other examples, the programming module 212 may create a reward program for a third payer/partner substantiation account. After receiving programming information to create one or more program profiles, the method 300 may proceed to step 310.

At step 310, one or more rules or conditions may be received. For example, the rules/conditions module 214 may prompt the payer/partner 106 to enter one or more rules or conditions associated with a program profile of a payer/partner substantiation account. For example, the rules/conditions module 214 may create different rules/conditions for different program files of the payer/partner substantiation account based at least in part on the rules or conditions received from the payer/partner 106. For example, the rules/conditions module 214 may create an inclusion/exclusion list of products or services associated with a program profile of a payer/partner substantiation account. The rules/conditions module 214 may create an inclusion/exclusion list that includes energy saving appliances and excludes appliances that consumes large amount of energy. In another example, the rules/conditions module 214 may create an inclusion/exclusion list that includes locally grown fruits and excludes imported fruits. The rules/conditions module 214 may create categories of products and services associated with the program profile of the payer/partner substantiation account based at least in part on the received rules or conditions. For example, the rules/conditions module 214 may create an electronic category associated with a program profile of a payer/partner substantiation account. In another example, the rules/conditions module 214 may create an apparel category associated with a program profile of a payer/partner substantiation account. After receiving one or more rules or conditions, the method 300 may proceed to step 312.

At step 312, a payment method may be received. The payment method module 216 may prompt the user to enter a payment method associated with a program profile of a payer/partner substantiation account. For example, the payer/partner 106 may select various types of payment methods for the program profile of a payer/partner substantiation account. The payer/partner 106 may select a gift card payment method, the payment method module 216 may create gift cards for the program profile of the payer/partner substantiation account. After receiving payment method, the method 300 may proceed to step 314.

At step 314, the payment or identification device 112 may be distributed. The payment method module 216 may create a type of payment or identification device 112 selected by the payer/partner 106. The payment method module 216 may distribute the payment or identification device 112 to desired consumers. The payment or identification device 112 having one or more rules or conditions may be substantiated by the merchant 102 to allow or prevent the consumers to purchase products or services. The consumers may be associated with the payer/partner 106. For example, the consumers may be a member of an organization. In another example, the consumers may be purchase services of the payer/partner 106. In other examples, the consumers may qualify for services provided by the payer/partner 106. After distributing payment or identification device 112, the method 300 may proceed to step 316.

At step 316, a summary report may be provided to a payer/partner 106. For example, the summary report module 222 may monitor and record transactions conducted using the distributed payment or identification device 112 associated with a program profile of a payer/partner substantiation account. The summary report module 222 may record transactions for each of the program profiles of a payer/partner substantiation account. The summary report module 222 may provide a statement of transactions associated with a program file of a payer/partner substantiation account for a predetermined and/or programmable period of time. The summary report module 222 may provide a statement of transactions associated with a payer/partner substantiation account for a predetermined and/or programmable period of time. For example, the summary report module 222 may provide a monthly statement for a food subsidy program. In another example, the summary report module 222 may provide a monthly statement for an insurance company that may have one or more program profiles. After providing summary report, the method 300 may proceed to step 318.

At step 318, the method 300 for substantiate a payment or identification device 112 having rules or conditions using the substantiation system 110 may be terminated.

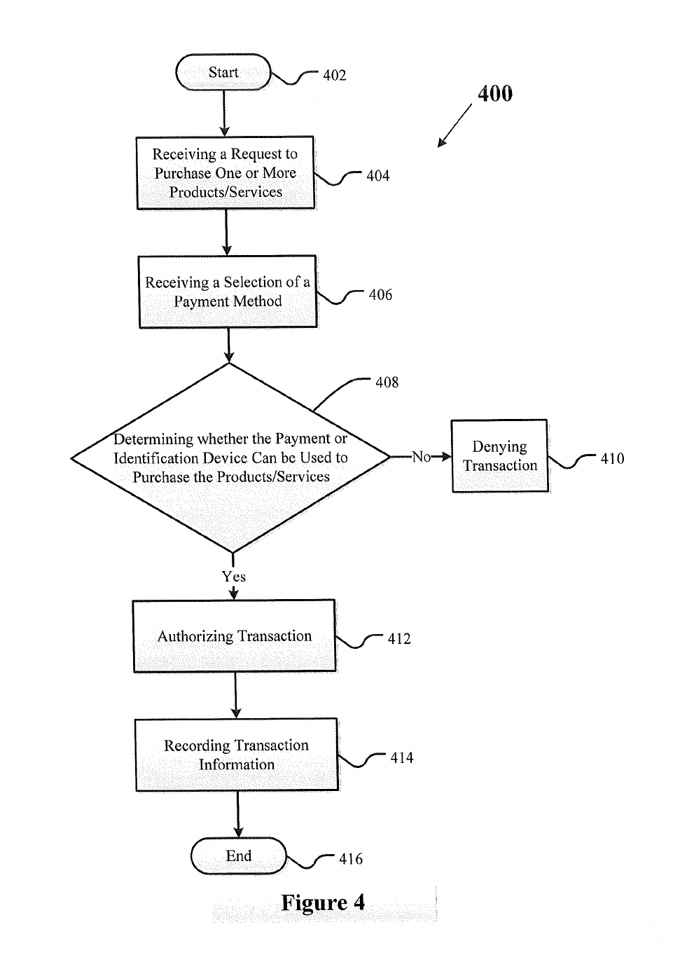

FIG. 4 is a flow chart illustrating a consumer using the substantiation system of the universal substantiation system in accordance with an embodiment of the present disclosure. This exemplary method 400 may be provided by way of example, as there are a variety of ways to carry out the method. The method 400 shown in FIG. 4 can be executed or otherwise performed by one or a combination of various systems. The method 400 is described below may be carried out by the systems and networks shown in FIGS. 1 and 2, by way of example, and various elements of the systems and networks are referenced in explaining the example method of FIG. 4. Each block shown in FIG. 4 represents one or more processes, methods or subroutines carried out in exemplary method 400. Referring to FIG. 4, exemplary method 400 may begin at step 402.

At step 402, the method 400 for substantiate a payment or identification device 112 having rules or conditions using the substantiation system 110 may be started.

At step 404, a request to purchase products or services may be received. For example, the point-of-sale (POS) module 220 may establish a communication with the point-of-sale (POS) terminal 108. When a consumer selects to purchase one or more products or services, the consumer may pay for the products or services at the point-of-sale (POS) terminal 108. The point-of-sale (POS) terminal 108 may identify products or services selected by the consumer to purchase. For example, a consumer may wish to purchase a child safety car seat, the consumer may take the child safety car seat to the point-of-sale (POS) terminal 108 for payment. The point-of-sale (PUS) terminal 108 may identify the child safety car seat by scanning an identification code of the child safety car seat. The point-of-sale (POS) terminal 108 may provide the identification code of the child safety car seat to the point-of-sale (POS) module 220 via the communication network 104. After receiving a request to purchase one or more products or services, the method 400 may proceed to step 406.

At step 406, a selection of payment method to purchase the products or services may be received. For example, the consumer may select various methods for paying the products or services. The consumer may select to pay for the products or services using the payment or identification device 112. The point-of-sale (POS) terminal 108 may identify the payment method and identification information associated with the payment or identification device 112. For example, the point-of-sale (POS) terminal 108 may identify that the payment or identification device 112 is a gift card. The point-of-sale (POS) terminal 108 may also identify an identification number associated with the payment or identification device 112. The point-of-sale (POS) terminal 108 may provide the payment method and identification information of the payment or identification device 112 to the payment method module 216 via the communication network 104. After receiving a selection of a payment method to purchase products or services, the method 400 may proceed to step 408.

At step 408, the processing module 204 may determine whether the payment or identification device 112 may be substantiated to purchase the products or services. The processing module 204 may access other modules of the substantiation system 110 to determine whether the payment or identification device 112 may be substantiated to purchase the products or services. For example, the processing module 204 may access the payment method module 216 to obtain the selected payment method and identification information associated with the payment or identification device 112. The processing module 204 may compare and contrast the identification information associated with the payment or identification device 112 with identification information stored at the identification module 218. In the event that the identification information associated with the payment or identification device 112 matches the identification information stored at the identification module 218, the processing module 204 may determine that the payment or identification device 112 is valid.

The processing module 204 may determine one or more program profiles that may be associated with the identification information associated with the payment or identification device 112. For example, the processing module 204 may access the programming module 212 to determine one or more program profiles associated with the identification information associated with the payment or identification device 112. Also, the processing module 204 may access rules/conditions module 214 to obtain rules or conditions that may be associated with the program profile. Thereafter, the processing module 204 may determine whether the payment or identification device 112 can be used to purchase the products or services. For example, a consumer may wish to purchase cough medicine using the payment or identification device 112 associated with a health and wellness program profile of a payer/partner substantiation account. The processing module 204 may identify that the payment or identification device 112 may be associated with a health and wellness program of an insurance company substantiation account. The processing module 204 may identify one or more rules or conditions stored at the rules/conditions module 214 of the health and wellness program profile. For example, the health and wellness program of the insurance company substantiation account requires the payment or identification device 112 only valid for generic medicine and not name brand medicine. The processing module 204 may determine whether the payment or identification device 112 associated with the health and wellness program profile can be used to purchase the cough medicine based at least in part on the rules and conditions of the health and wellness program profile. In the event that the payment or identification device 112 cannot be used to purchase the products or services, the method 400 may proceed to step 410. In the event that the payment or identification device 112 can be used to purchase the products or services, the method 400 may proceed to step 412.

At step 410, transaction to purchase the products or services may be denied. For example, the processing module 204 may determine that the products or services for purchase violate one or more rules or conditions associated with a program profile of a payer/partner substantiation account and denies the transaction. For example, the processing module 204 may determine that the cough medicine is a name brand and only generic brand medicine qualifies for the health and wellness program profile and thus denies the transaction. The processing module 204 may provide a denying message to the point-of-sale (POS) terminal 108 via the communication network 104. The processing module 204 may provide a reason for denying the purchase of the products or services. For example, the processing module 204 may provide a message to the point-of-sale (POS) terminal 108 that the purchased medicine is name brand and only generic brand medicines qualify for the health and wellness program profile.

At step 412, transaction to purchase products or services may be authorized. For example, the processing module 204 may determine that the products or services for purchase do not violate any rules or conditions associated with a program profile of a payer/partner substantiation account, the processing module 204 may authorize the transaction to purchase the products or services. For example, the processing module 204 may determine that the cough medicine is a generic brand qualified under the rules or conditions of the health and wellness program profile and thus authorizes the transaction. The processing module 204 may provide an authorization message to the point-of-sale (POS) terminal 108 via the communication network 104. After authorizing transaction to purchase products or services, the method 400 may proceed to step 414.

At step 414, the transaction information may be recorded. For example, the summary report module 222 may record transaction information associated with the authorized transaction. For example, the summary report module 222 may record the payer/partner substantiation account, program profile, payment method, payment or identification device identification information, date, time, transaction amount, location of the point-of-sale (POS) terminal 108, and/or other information associated with the purchase of the products or services. After recording transaction information, the method 400 may proceed to step 416.

At step 416, the method 400 for substantiate a payment or identification device 112 having rules or conditions using the substantiation system 110 may be terminated.

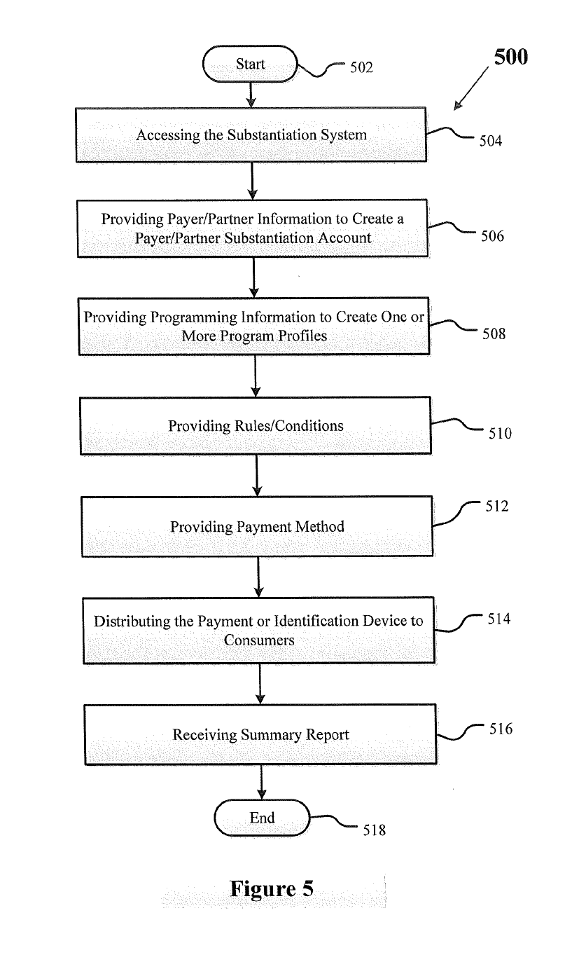

FIG. 5 is a flow chart illustrating the functionality of the substantiation system 110 of the universal substantiation system 100 according to an embodiment of the present disclosure. This exemplary method 500 may be provided by way of example, as there are a variety of ways to carry out the method. The method 500 shown in FIG. 5 can be executed or otherwise performed by one or a combination of various systems. The method 500 is described below may be carried out by the systems and networks shown in FIGS. 1 and 2, by way of example, and various elements of the systems and networks are referenced in explaining the example method of FIG. 5. Each block shown in FIG. 5 represents one or more processes, methods or subroutines carried out in exemplary method 500. Referring to FIG. 5, exemplary method 500 may begin at step 502.

At step 502, the method 300 for substantiate a payment or identification device 112 using the substantiation system 110 may be started.

At step 504, a payer/partner 106 may access the substantiation system 110. For example, the payer/partner 106 may establish a communication with the substantiation system 110 via the communication module 202 and the communication network 104. The communication module 202 may enable a communication between the payer/partner 106 and the substantiation system 110. The payer/partner 106 may access the substantiation system 110 to allow or prevent the purchase of products or services using a payment or identification device 112 having rules or conditions. After accessing the substantiation system 110, the method 500 may proceed to step 506.

At step 506, the payer/partner may input payer/partner information to create a payer/partner substantiation account. The payer/partner module 208 may prompt the payer/partner 106 to enter payer/partner identification information. For example, the payer/partner module 208 may provide a graphical user interface (GUI) that may allow the payer/partner 106 to enter payer/partner identification information. The payer/partner 106 may provide the payer/partner identification information via the graphical user interface (GUI) provided by the payer/partner module 208. The payer/partner identification information may include name, address, phone number, electronic mail address, website address, revenue, profit, number of employees, types of payer/partner, contact person of the payer/partner and/or other information that may identify the payer/partner 106. The payer/partner module 208 may store payer/partner identification information. Also, the payer/partner module 208 may provide the payer/partner identification information to other modules of the substantiation system 110. The payer/partner module 208 may enable the payer/partner 106 access to the products/services catalog listing system 210. For example, the payer/partner module 208 may enable the payer/partner 106 to offer payment or identification device 116 to the consumer via the products/services catalog listing system 210.

The substantiation system 110 may establish a payer/partner substantiation account based at least in part on the payer/partner identification information. For example, the payer/partner account module 210 may obtain payer/partner identification information from the payer/partner module 208. The payer/partner account module 210 may establish a payer/partner substantiation account based at least in part on the payer/partner identification information. The payer/partner account module 210 may assign a reward to the payer/partner substantiation account. For example, the payer/partner account module 210 may assign different rewards to different levels of payer/partner substantiation account. The payer/partner account module 210 may assign no reward for silver level payer/partner substantiation account. The payer/partner account module 210 may assign one percent reward for gold level payer/partner substantiation account. The payer/partner account module 210 may also assign two percent reward for platinum level payer/partner substantiation account. For example, the payer/partner account module 210 may assign a level to a payer/partner substantiation account based at least in part on an amount of transaction conducted by the payer/partner 106. After providing payer/partner information to create a payer/partner substantiation account, the method 500 may proceed to step 508.

At step 508, the payer/partner 106 may provide programming information to create one or more program profiles. For example, the programming module 212 may prompt the payer/partner 106 to enter programming information to create a program profile associated with the payment or identification device 112. The payer/partner 106 may provide programming information via a graphical user interface (GUI) provided by the programming module 212. The programming module 212 may establish one or more program profiles for each of the payer/partner substantiation account based at least in part on the received programming information. For example, a payer/partner 106 may choose to have a plurality of programs and the programming module 212 may create a plurality of program profiles for each of the plurality of programs associated with the payer/partner substantiation account. A health provider payer/partner may provide programming information for a medication program and a health screening program. The programming module 212 may create a medication program profile and a health screening program profile for the health provider payer/partner. In another example, the programming module 212 may create a financial program for a first payer/partner substantiation account. In other examples, the programming module 212 may create a disaster relief program for a second payer/partner substantiation account. In other examples, the programming module 212 may create a reward program for a third substantiation account. After providing programming information to create one or more program profiles, the method 500 may proceed to step 510.

At block 510, the payer/partner 106 may provide one or more rules or conditions. For example, the rules/conditions module 214 may prompt the payer/partner 106 to enter one or more rules or conditions associated with a program profile of a payer/partner substantiation account. The payer/partner 106 may provide one or more rules or conditions via a graphical user interface (GUI) provided by the rules/conditions module 214. For example, the rules/conditions module 214 may create different rules/conditions for different program files of the payer/partner substantiation account based at least in part on the rules or conditions received from the payer/partner 106. For example, the rules/conditions module 214 may create an inclusion/exclusion list of products or services associated with a program profile of a payer/partner substantiation account. The rules/conditions module 214 may create an inclusion/exclusion list that includes organic food items and excludes non-organic food items. In another example, the rules/conditions module 214 may create an inclusion/exclusion list that includes low fat products and excludes high fat products. The rules/conditions module 214 may create categories of products and services associated with the program profile of the payer/partner substantiation account based at least in part on the received rules or conditions. For example, the rules/conditions module 214 may create a jewelry category associated with a program profile of a payer/partner substantiation account. In another example, the rules/conditions module 214 may create a car service category associated with a program profile of a payer/partner substantiation account. In other examples, the rules/conditions module 214 may create a flexible spending account program, a supplemental nutrition assistance program or a women, infants and children program or any other government sponsored programs. After providing one or more rules or conditions, the method 500 may proceed to step 512.

At step 512, the payer/partner 106 may provide a payment method. The payment method module 216 may prompt the payer/partner 106 to enter a payment method associated with a program profile of a payer/partner substantiation account. The payer/partner 106 may provide a payment method via a graphical user interface (GUI) provided by the payment method module 216. For example, the payer/partner 106 may select various types of payment methods for the program profile of a payer/partner substantiation account. For example, the payer/partner 106 may select a gift card payment method, the payment method module 216 may create gift cards for the program profile of the payer/partner substantiation account. After providing a payment method, the method 500 may proceed to step 514.

At step 514, the payment or identification device 112 may be distributed. The payer/partner 106 may receive a type of payment or identification device 112 selected by the payer/partner 106. The payer/partner 106 may distribute the payment or identification device 112 to desired consumers. The payment or identification device 112 having one or more rules or conditions may be substantiated by the merchant 102 to allow or prevent the consumers to purchase products or services. The consumers may be associated with the payer/partner 106. For example, the consumers may be a member of the payer/partner 106. In another example, the consumers may be purchase services of the payer/partner 106. In other examples, the consumers may qualify for services provided by the payer/partner 106. After distributing payment or identification device 112, the method 500 may proceed to step 516.

At step 516, a payer/partner 106 may receive a summary report. For example, the summary report module 222 may monitor and record transactions conducted using the distributed payment or identification device 112 associated with a program profile of a payer/partner substantiation account. The summary report module 222 may record transactions for each of the program profiles of a payer/partner substantiation account. The summary report module 222 may provide a summary statement of transactions associated with a program file of a payer/partner substantiation account for a predetermined and/or programmable period of time. The summary report module 222 may provide a summary statement of transactions associated with a payer/partner substantiation account for a predetermined and/or programmable period of time. For example, the summary report module 222 may provide a monthly statement for a meal plan program. In another example, the summary report module 222 may provide a monthly statement for an insurance company that may have a child car seat program and a health screening program. After receiving summary report, the method 500 may proceed to step 518.

At step 518, the method 500 for substantiate a payment or identification device 112 using the substantiation system 110 may be terminated.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A system for substantiating a payment device, comprising:
at least one computer processor configured to implement:
a payer/partner module configured to receive payer/partner identification information from a payer/partner, the payer/partner being an entity or an organization that provides one or more rules or conditions associated with the payment device;
a payer/partner account module configured to create a payer/partner substantiation account based at least in part on the payer/partner identification information, wherein the payer/partner account module is further configured to assign one of a plurality of levels to the payer/partner substantiation account, each one of the plurality of levels being based on a monetary value associated with a transaction carried out using the payment device;
a programming module configured to receive programming information to create one or more program profiles for the payer/partner substantiation account; and
a rules/conditions module configured to receive the one or more rules or conditions for the payment device associated with the one or more program profiles of the payer/partner substantiation account, wherein the one or more rules or conditions control products or services that can be purchased using the payment device.

2. The system of claim 1, wherein the payer/partner identification information comprise at least one of a name, an address, a phone number, an electronic mail address, a website address, revenue, profit, number of employees, types of payer/partner, contact person of the payer/partner.

3. The system of claim 1, wherein the payer/partner account module is further configured to assign one of the plurality of levels to the payer/partner substantiation account based at least in part on the payer/partner identification information.

4. The system of claim 1, wherein the rules/conditions module is further configured to offer rewards for an usage of the payment device.

5. The system of claim 1, wherein the one or more rules or conditions comprise a list of products or services that are included or excluded for purchasing using the payment device.

6. The system of claim 1, wherein the one or more rules or conditions comprise a category of products or services created by the payer/partner.

7. The system of claim 1, further comprising a processing module configured to determine whether the payment device with the associated one or more rules and conditions can be used to purchase products or services.

8. The system of claim 1, further comprising a payment method module configured to receive a selection of a type of the payment device.

9. The system of claim 8, wherein the type of the payment device comprises at least one of a credit card, a debit card, a stored-value card, a gift card, a voucher card, a wage card, a virtual card, an electronic-email, a membership card, an identification card, an email, a code, a pattern and a digital certificate.

10. The system of claim 1, further comprising a summary report module configured to provide a summary statement of the one or more program profiles of the payer/partner substantiation account.

11. A method for substantiating a payment device comprising:
receiving, at a processor of a payer/partner module, payer/partner identification information from a payer/partner to create a payer/partner substantiation account, the payer/partner being an entity or an organization that provides one or more rules or conditions associated with the payment device;
receiving, at the processor, programming information to create one or more program profiles for the payer/partner substantiation account;
receiving, at the processor, the one or more rules or conditions for the payment device associated with the one or more program profiles of the payer/partner substantiation account, wherein the one or more rules control products or services that can be purchased using the payment device; and
assigning, at the processor, one of a plurality of levels to the payer/partner substantiation account, each one of the plurality of levels being based on a monetary value associated with a transaction carried out using the payment device.

12. The method of claim 11, wherein the payer/partner identification information comprise at least one of a name, an address, a phone number, an electronic mail address, a website address, revenue, profit, number of employees, types of payer/partner, contact person of the payer/partner.

13. The method of claim 11, further comprising assigning one of the plurality of levels to the payer/partner substantiation account based at least in part on the payer/partner identification information.

14. The method of claim 11, wherein the one or more rules or conditions comprise rebates for an usage of the payment device.

15. The method of claim 11, wherein the one or more rules or conditions comprise a list of products or services that are included or excluded for purchasing using the payment device.

16. The method of claim 11, wherein the one or more rules or conditions comprise a category of products or services created by the payer/partner.

17. The method of claim 11, further comprising determining whether the payment device having the one or more rules and conditions can be used to purchase products or services.

18. The method of claim 11, further comprising receiving a selection of a type of the payment device.

19. The method 18, wherein the type of the payment device comprises at least one of a credit card, a debit card, a stored-value card, a gift card, a voucher card, a wage card, a virtual card, an electronic-email, a membership card, and an identification card.

20. The method of claim 11, further comprising providing a summary statement of the one or more program profiles of the payer/partner substantiation account.
